(19) United States
(12) Patent Application Publication
(10) Pub. No.: US 2014/0341668 A1
(43) Pub. Date: Nov. 20, 2014

(54) METHOD FOR TOOTH-MACHINING WORKPIECES

(71) Applicant: Liebherr-Verzahntechnik GmbH, Kempten (DE)

(72) Inventor: Hansjoerg Geiser, Wiggensbach (DE)

(21) Appl. No.: 14/272,402

(22) Filed: May 7, 2014

(30) Foreign Application Priority Data
May 14, 2013 (DE) 10 2013 008 214.5
Jun. 17, 2013 (DE) 10 2013 010 246.4

(51) Int. Cl. B23F 17/00

(52) U.S. Cl. CPC B23F 17/008; B23F 17/001
USPC 409/6

(57) ABSTRACT

The present disclosure relates to a method for tooth-machining workpieces on a gear cutting machine, wherein the gear cutting machine includes at least one main machining station and at least one secondary station with at least two workpiece spindles. The two workpiece spindles are alternately traversed into the working region of the main machining station and the secondary station. The method further includes a fine toothing step, in which a workpiece arranged at one of the workpiece spindles is subjected to fine toothing at a main machining station, and a secondary machining step, in which a workpiece arranged at one of the workpiece spindles is subjected to secondary machining at a secondary station by material removal and/or material forming.

### CROSS REFERENCE TO RELATED APPLICATIONS

This application claims priority to German Patent Application No. 10 2013 008 214.5, entitled “Method for Tooth-Machining Workpieces,” filed May 14, 2013, and also claims priority to German Patent Application No. 10 2013 010 246.4, entitled “Method for Tooth-Machining Workpieces,” filed Jun. 17, 2013, both of which are hereby incorporated by reference in their entirety for all purposes.

### TECHNICAL FIELD

The present disclosure relates to a method for tooth-machining workpieces on a gear cutting machine which includes at least one main machining station, at least one secondary station and at least two traversable or pivotable workpiece spindles which either are arranged on a common workpiece spindle carrier or are traversable independent of each other. By pivoting the workpiece spindle carrier or by traversing the workpiece spindles, the two workpiece spindles are alternately moved into the working region of the main machining station and the secondary station.

### BACKGROUND AND SUMMARY

A method is known from document DE 10 2006 044738 B3, wherein a production process, one of the workpiece spindles is loaded at a loading position, while at the same time a first rough milling process is carried out at the second workpiece spindle with a gear milling tool. After terminating the first milling process, the position of the two workpiece spindles is changed by rotating the workpiece spindle holder about its main axis of rotation. The roughly machined workpiece thus comes from the milling position into the loading position, while the unmachined workpiece subsequently is in the main machining position.

Now, a chamfering process is carried out at the workpiece spindle in the loading position, in which one or more roller deburring tools are used. By this chamfering process, workpiece material which is located in the region of the front edge of the toothing is forced to the outside on the end faces of the toothing. This material is sheared off there by deburring wheels resting against the end faces of the toothing. A further part of this workpiece material is pressed into the tooth flank. Simultaneously with the chamfering process, the rough milling process of the other workpiece takes place on the other workpiece spindle.

After another rotation of the workpiece spindle holder about its main axis, the workpiece spindle with the workpiece deburred in the meantime again is located at the main machining station, where it is subjected to a fine milling process. This step serves to remove workpiece material, which has been pressed into the tooth flank by the roller deburring process, in a final smoothing cut. Parallel to this fine milling cut, the roughly milled workpiece arranged on the other tool spindle is roller-deburred.

When the smoothing cut and the roller deburring process are terminated, the two workpiece spindles again change their position by a further rotary movement of the workpiece spindle holder. The fine-machined and hence finished workpiece now is exchanged for an untoothed workpiece by an external loading means, while at the same time the roller-deburred workpiece on the other spindle is subjected to the final fine-toothing step. Subsequently, this process sequence starts again.

In this procedure known from DE 10 2006 044738 B3 it is disadvantageous that the respective processes, which act on the workpiece spindles or on the workpieces arranged there, influence each other due to the arrangement of the two workpiece spindles on a common workpiece spindle holder. Above all the roller deburring process has a negative influence. This process is a forming process which radially acts on the workpiece clamped at the workpiece spindle. This in turn leads to a radial force on the workpiece spindle, which via the common workpiece spindle holder also acts on the other workpiece spindle.

As long as only the rough toothing step takes place there, this is not very important, since toothing errors occurring in this process step would be removed again by the final fine toothing step. But when the final fine toothing step takes place there, the influences will show in the form of toothing errors at the workpiece.

According to DE 10 2006 044738 B3, these influences of roller deburring should be prevented in that two roller deburring tools at the same time each act on the workpiece from opposite sides. However, this involves a distinctly increased expenditure, since the roller deburring tools are very expensive tools, so that a considerable investment for the double tool number per type of workpiece must be reckoned with. In addition, the roller deburring means holder of the roller deburring tools must be designed twice, as always two tools are in use at the same time. Furthermore, this arrangement cannot completely prevent that influences of the roller deburring process have an effect on the fine toothing process.

When the workpieces toothed in this way are used without a final hard finishing process, the method known from DE 10 2006 044738 B3 has a quality-reducing effect on the finished toothing. In a subsequent hard finishing process, the flank allowance and also the flank size might be chosen smaller, when the quality of the milled toothing was better. For the hard finishing process, the machining allowance on the flank then can be chosen smaller. The chamfers hence can become smaller and nevertheless still are present after hard finishing and can fulfill their protective function for the edges of the toothing. This saves the roller deburring tool and the forming forces for producing the chamfers become smaller.

Therefore it is the object of the present disclosure to provide a method for tooth-machining, which with a rather low constructive expenditure provides a rather high toothing quality.

According to the present disclosure, this object is solved by a method for tooth-machining workpieces on a gear cutting machine, which includes at least one main machining station, at least one secondary station and at least two workpiece spindles. In particular, the gear cutting machine includes at least two traversable workpiece spindles which either are arranged on a common workpiece spindle holder pivotable about a main pivot axis and are traversable by pivoting the workpiece spindle holder about the main pivot axis or are traversable independent of each other, in particular by linearly traversing or pivoting the separate machine tables associated to the workpiece spindles. The two workpiece spindles alternately are traversed into the working region of the main machining station and the secondary station, in particular by pivoting the workpiece spindle holder about the main pivot axis or by separately traversing the workpiece spindles. The method for tooth-machining the workpieces on the one hand includes a fine toothing step, in which a workpiece arranged at one of the workpiece spindles is fine-toothed at the main machining station. Fine toothing is the process step which determines the quality of the toothing. Furthermore, the method according to the present disclosure comprises a secondary machining step, in which a workpiece arranged at one of the workpiece spindles is subjected to secondary machining at the secondary station by material removal and/or material forming. According to the present disclosure it is provided that for the duration of the fine toothing carried out at the main machining station no secondary machining each is effected at the secondary station.

According to the present disclosure, the secondary machining step, in which a workpiece arranged at one of the workpiece spindles is subjected to secondary machining at the secondary station by material removal and/or material forming, hence is effected either before and/or after fine toothing, but never simultaneously with fine toothing. Without any constructive expenditure it thereby is prevented that secondary machining influences the quality of fine toothing. In particular, for the duration of the fine toothing carried out at the main machining station no secondary machining is effected at the secondary station, which would influence the toothing quality achievable by fine toothing.

In the method according to the present disclosure, a loading and/or unloading step furthermore can be carried out at the secondary station or at a further secondary station, in which a completely toothed workpiece is removed from a workpiece spindle and a blank is arranged at the workpiece spindle.

In the method according to the present disclosure, a measuring, positioning and/or marking cycle furthermore can take place at the or a secondary station, while a workpiece is present at this station. For example, a positioning task can take place before tooth-machining, in which the workpiece is positioned corresponding to a bore or reference surface. Furthermore, it is possible to measure the workpiece after tooth-machining, in order to carry out for example a statistic process control (SPC).

In one example, for the duration of the fine toothing carried out at the main machining station there is carried out neither the secondary machining step at the secondary station nor the loading and/or unloading step.

In one example, for the duration of the fine toothing carried out at the main machining station no mechanical action at all can be effected on the workpiece spindle arranged at the secondary station and/or on the workpiece arranged at the same. In this way, any negative influence on the fine toothing is prevented.

The method according to the present disclosure for tooth-machining workpieces furthermore can include a rough toothing step, in which a workpiece arranged at one of the workpiece spindles is subjected to rough toothing at the main machining station. Preferably, a rough toothing step and a fine toothing step are carried out at the workpieces one after the other. Furthermore preferably, the secondary machining step is effected between the rough toothing step and the fine toothing step.

Rough toothing also is referred to as roughing, fine toothing is referred to as smoothing.

When carrying out the method according to the present disclosure during the rough toothing carried out at the main machining station, the secondary machining step and/or the loading and/or unloading step may be carried out at the secondary station. Short process times thereby can also be realized in the present method, as some of the steps of the method according to the present disclosure are carried out at the same time. Since the execution of the secondary processes such as for example secondary machining and/or loading and unloading, however, is not effected during the fine toothing step, but during the rough toothing step, the method according to the present disclosure does not lead to a deterioration of the toothing quality. Possible influences of the secondary steps on the rough toothing step are eliminated again by the subsequent fine toothing step.

In one possible embodiment of the method according to the present disclosure, the secondary machining step always can be carried out only during the rough toothing step and/or while at the main machining station no machining of the workpiece arranged there is effected.

In one example, at the toothing machine according to the present disclosure at least two workpieces are machined at the same time, wherein the workpieces undergo the individual machining steps one after the other and for carrying out the respective steps by traversing the workpiece spindles, in particular by pivoting the workpiece spindle carrier or by separately traversing the workpiece spindles are traversed from the secondary station to the main machining station and back. The workpieces can change their places with each pivoting or traversing of the workpiece spindle.

The gear cutting method according to the present disclosure can be a gear milling method. In this method, the workpiece is machined with a milling tool at the main machining station. In particular, the gear milling method can comprise the main machining steps of rough milling as well as fine milling, and as steps carried out at the secondary station the loading and unloading of the workpiece spindles, measuring and positioning tasks, and as secondary machining step a temporally subordinate mechanical machining process such as e.g. deburring, drilling, turning or milling. It is important that this secondary process does not take longer than the main machining step. In particular, the sequence of the steps can comprise the loading of the workpiece spindle, a rough milling of the workpiece, a deburring of the rough-milled workpiece, a fine milling, and then an unloading of the workpiece spindle. In possible embodiments of the present disclosure, the gear milling method is a gear hobbing method or a profile milling method.

In an alternative embodiment of the present disclosure, the present method can be a gear shaping method. In this method, the workpieces are toothed at the main machining station by a shaping tool. Such gear shaping method can comprise the main steps of rough gear shaping (in one or several steps) as well as fine gear shaping, and as steps carried out at the secondary station the loading and unloading of the workpiece spindles, measuring and positioning tasks, and as secondary machining step a temporally subordinate mechanical machining process such as e.g. deburring, drilling, turning or milling. It is important that this secondary process does not take longer than the main machining step. A further rough toothing cut carried out after the first rough toothing cut also is referred to as leveling. The sequence of the gear shaping method can be as follows: Loading of the workpiece spindle, rough gear shaping, deburring, leveling, fine gear shaping and unloading of the workpiece spindle. The gear shaping method preferably is a gear planing method.

The deburring process preferably is a press deburring process. Alternatively, however, a chamfer-cut process or a chamfer-milling deburring process can be used.

In a first variant of the present disclosure, the method according to the present disclosure can include the following steps: Traversing of the workpiece spindles, in particular by pivoting the workpiece spindle holder or independently traversing the individual workpiece spindles, so that the first workpiece spindle gets into the working region of a main machining station and the second workpiece spindle gets into the working region of a secondary station, fine toothing of a workpiece picked up at the first workpiece spindle, without carrying out a secondary machining at the secondary station, and traversing of the workpiece spindles, in particular by pivoting the workpiece spindle holder or traversing the individual workpiece spindles, so that the first workpiece spindle gets into the working region of the secondary station and the second workpiece spindle gets into the working region of the main machining station. As compared to the method known from the prior art, the method according to the present disclosure requires at least one additional traversing step, as during fine toothing no secondary machining is carried out at the secondary station. In a particularly preferred embodiment, no loading and/or unloading is carried out either at the secondary station during fine toothing.

In a first variant, this method comprises the further step of unloading the fine-toothed workpiece from the first workpiece spindle and of loading the workpiece spindle with a new workpiece, without carrying out a main machining step at the main machining station. Only after newly traversing the workpiece spindles, in particular by pivoting the workpiece spindle holder or traversing the individual workpiece spindles, will a main machining step be carried out at the main machining station, preferably the rough toothing of the workpiece newly picked up before.

In this design variant the additional loading and unloading step is required, in order to be able to again carry out the individual traversing steps at the two stations in the intended sequence, despite refraining from machining at the secondary station during fine toothing.

When the workpiece spindles are not arranged on a common workpiece spindle holder and the workpiece spindles can be traversed between the individual stations independent of each other, this results in time advantages, so that e.g. the spindles can already be newly positioned when their machining process is terminated without the actual main process having to be terminated. This variant of process control is of interest above all when the main process also is split up, as described in the following embodiment.

The method comprises the further step of unloading the fine-toothed workpiece from the first workpiece spindle and of loading the workpiece spindle with a new workpiece, while at the main machining station at least a part of a main machining step is carried out. Depending on the length of the individual steps, this results in an acceleration of the method, as during unloading at least a part of a main machining step can be carried out. Preferably, this is at least a part of a rough toothing step.

According to an embodiment of the present disclosure, a main machining step carried out at the main machining station can be divided into two partial steps between which the workpiece spindles are traversed, in particular by pivoting the workpiece spindle holder or by individually traversing the workpiece spindles. In particular, the main machining step which is divided into two partial steps can be the rough toothing step. Preferably, the main machining step is divided into two parts, in order to traverse the workpiece spindles between the two partial steps, in particular to pivot the workpiece spindle holder or to individually traverse the workpiece spindles and to fine-tooth a workpiece arranged at the other workpiece spindle. By dividing a main machining step into two partial steps, the process time of the entire method is reduced depending on the length of the respective steps, as due to the now two-part execution of the main machining step, in particular of rough toothing, secondary steps can each be carried out at the secondary station simultaneously with the two steps.

During the first partial step the other workpiece spindle is unloaded and loaded, and during the second partial step a secondary machining is carried out at the other workpiece spindle, in particular a deburring process, or vice versa.

The present disclosure makes use of the fact that the rough toothing step usually is the longest process step. Due to the division into two partial steps, two shorter secondary steps thus can be carried out at the secondary station, while the first and the second partial step each are carried out at the main machining station.

The division for example can be effected such that in the first partial step at least a part of the initial cut is made, in which the tool immerses into the workpiece. The second partial step can be a profiling step, in which the profile of the toothing is formed on the workpiece.

The main machining step also can be divided into more than two partial steps. Particularly preferably, however, it is divided into exactly two partial steps.

In the embodiment with the independently traversable workpiece spindles it is attempted to temporally adjust the partial processes at the main and secondary machining stations to each other by a clever division of the process, in order to minimize the unproductive waiting times and thus obtain a temporally optimized machining process. Furthermore, it is possible to independently increase the number of the main and secondary machining stations depending on the process requirement. Thus, for example a main machining station can be combined with a plurality of secondary machining stations, with a reverse embodiment also being conceivable.

In a further embodiment according to the present disclosure the method can include the following steps: Traversing of the workpiece spindles, in particular by pivoting the workpiece spindle holder or traversing the individual workpiece spindles, so that the first workpiece spindle gets into the working region of the main machining station and the second workpiece spindle gets into the working region of the secondary station, fine toothing of a workpiece picked up at the first workpiece spindle and carrying out the secondary machining and/or the unloading and loading steps at the secondary station in at least two non-overlapping time intervals, and traversing of the workpiece spindles, in particular by pivoting the workpiece spindle holder or traversing the individual workpiece spindles, so that the first workpiece spindle gets into the working region of the secondary station and the second workpiece spindle gets into the working region of the main machining station. In this method, both fine toothing and the secondary machining and/or unloading and loading is effected between the two method steps, i.e., steps are carried out both at the main and at the secondary station. The steps, however, are not effected in parallel, so that the secondary machining and/or unloading and loading cannot have any negative influence on fine toothing. Preferably, the respective steps are effected one after the other. For example, fine toothing can be carried out first, and after terminating the same, secondary machining and/or unloading and loading is effected at the other workpiece spindle.

Due to this procedure, the number of the method steps need not be increased as compared to known gear cutting methods, which again can accelerate the process sequence.

Beside the described methods, the present disclosure furthermore comprises a gear cutting machine with at least one main machining station, at least one secondary station and at least two workpiece spindles. In particular, the gear cutting machine includes at least two traversable workpiece spindles which either are arranged on a common workpiece spindle holder pivotable about a main pivot axis and are traversable by pivoting the workpiece spindle holder about the main pivot axis or are traversable independent of each other, in particular by linearly traversing or pivoting separate machine tables associated to the workpiece spindles. The two workpiece spindles are alternately traversable into the working region of the main machining station and the secondary station, in particular by pivoting the workpiece spindle holder about the main pivot axis or by separately traversing the workpiece spindles. Furthermore, the gear cutting machine comprises a controller for automatically carrying out a method as it has been described above. The controller of the gear cutting machine according to the present disclosure hence implements a method as it has been set forth above, automated on a gear cutting machine.

The present disclosure furthermore comprises a computer program, in particular a computer program stored non-transitorily on a data carrier or in a memory, which comprises commands for automatically carrying out a method according to the present disclosure, as it has been described above. In particular, the computer program according to the present disclosure can be loaded into the controller of a gear cutting machine, in order to implement a method according to the present disclosure on the same.

A gear cutting machine according to the present disclosure can be constructed such that at the secondary station both a secondary machining and the loading and unloading of the workpieces is effected. Furthermore, the workpiece spindle holder can include at least two swivel positions, wherein in the first swivel position the first workpiece spindle is arranged in the working region of the main machining station and the second workpiece spindle is arranged in the working region of the secondary station, and wherein in the second swivel position the first workpiece spindle is arranged in the working region of the secondary station and the second workpiece spindle is arranged in the working region of the main machining station. Furthermore, it can be provided that in the case of two workpiece spindles the same are arranged at the workpiece spindle holder offset by 180° with respect to the main swivel axis.

Alternatively, two separate secondary stations also can be provided for the secondary machining as well as the loading and unloading of the workpieces. Preferably, the workpiece spindle holder has at least three swivel positions or the traversable workpiece spindles can be stopped and positioned at three positions. Of course, it is also possible to combine two main stations with a secondary station, depending on the time requirements of the process.

The workpiece spindles each can include a drive with which a workpiece clamped at the workpiece spindle can be rotated about an axis of rotation. Possibly, the workpiece spindles also can include a counter-bracket which preferably is arranged at the workpiece spindle holder.

The main machining station can include a milling head, a shaping drive or a grinding head with the corresponding NC axes.

At the secondary station, there can be arranged a tool for secondary machining, in particular a deburring tool, particularly preferably a press deburring tool. Alternatively or in addition, an automation for loading and unloading the workpiece spindle can be arranged at the secondary station.

The present disclosure will now be explained in detail with reference to exemplary embodiments and drawings.

### BRIEF DESCRIPTION OF THE FIGURES

FIG. 1 shows a first exemplary embodiment of the present disclosure, in which the fine toothing step is carried out between two traversing movements of the workpiece spindles, without a process being carried out at the secondary station, and in which for reproducing the sequence of the process steps during loading and unloading no process step is carried out at the main machining station.

FIG. 2 shows a second exemplary embodiment of a method according to the present disclosure, in which a process step is divided into two partial steps, in order to be able to carry out processes for a major amount of the process times both at the main machining station and at the secondary station.

FIG. 3 shows a third exemplary embodiment of a method according to the present disclosure, in which fine toothing and a process step at the secondary station are carried out during the same traversing cycle, but offset in time.

FIG. 4 shows a fourth exemplary embodiment of a method according to the present disclosure, in which in connection with a gear shaping method an additional rough toothing step is carried out before fine toothing, during which a secondary machining and/or loading and unloading is effected.

FIGS. 5a-e show an overview of exemplary machine concepts for carrying out the method according to the present disclosure.

FIG. 6 is an example machine.

### DETAILED DESCRIPTION

According to all embodiments of the present disclosure, during the quality-determining process phase, i.e. fine toothing, no machining is carried out on the other workpiece spindle, which might negatively influence this process. Depending on the length of the individual process phases and the method concretely carried out, different process controls are available for optimizing the entire machining time.

In the following, different exemplary embodiments are provided for this purpose. In this exemplary embodiment the procedure is illustrated with reference to gear hobbing, in which the individual method steps of roughing, i.e. rough toothing, deburring, in particular roller deburring, smoothing, i.e. fine toothing, as well as loading and unloading are carried out. Between the individual steps there is at least one change of the workpiece spindle holder position. The sequence then is loading and unloading, roughing, deburring, smoothing and again loading and unloading.

The present disclosure, however, can also be used in the same way for gear planing This method involves an additional method step, namely leveling. The sequence of the process steps is roughing, leveling, smoothing and then roller deburring as well as loading and unloading.

By a clever combination of the process sequences, taking into account the restrictions that during the phase of quality formation no machining process takes place on the other spindle, different process variants thus are obtained.

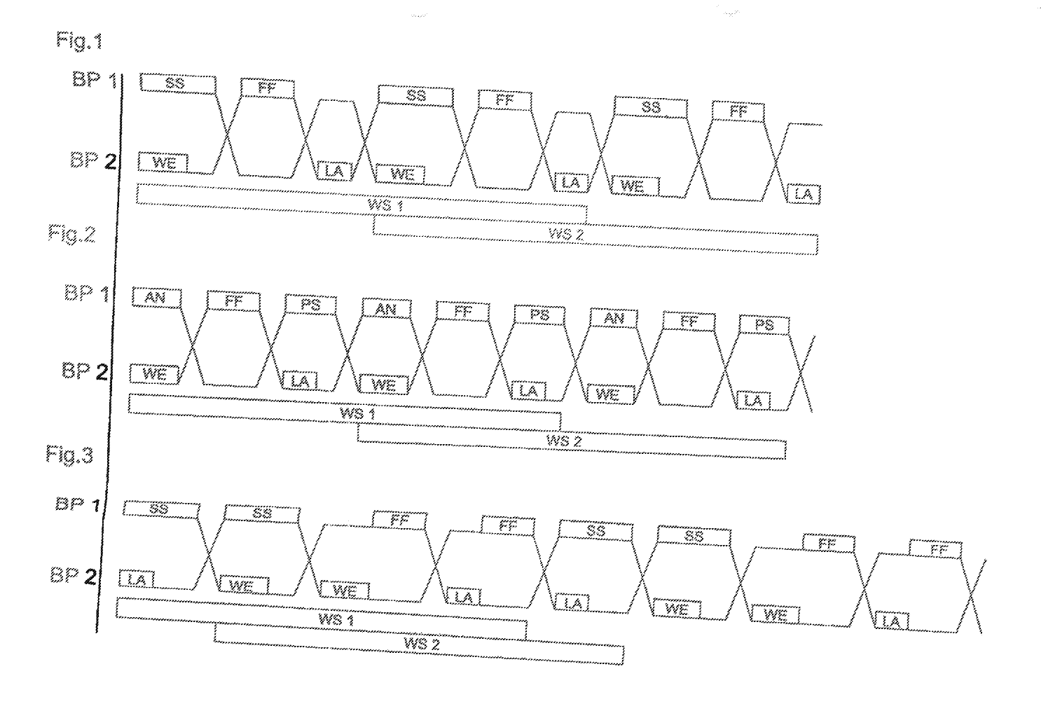

During gear hobbing the roughing process, i.e. rough milling, usually takes longest. In the process variants shown in FIGS. 1 and 2 the deburring process, in particular a roller deburring process, therefore each is carried out during the roughing cut. The smoothing cut, on the other hand, is carried out separately, so as not to influence this process by a process taking place in parallel.

In the exemplary embodiment shown in FIG. 1, nothing is changed in the usual process sequence with regard to the sequence of the process steps performed. With respect to each individual workpiece spindle, there is rather also effected a step of loading and unloading (LA), rough toothing (SS), deburring (WE), fine toothing (FF) and again loading and unloading (LA). Due to the fact that the step of deburring (WE), however, always is carried out only during rough toothing (SS), but not during fine toothing (FF), deburring cannot be effected directly subsequent to rough toothing (SS). Rather, while fine-toothing a workpiece on the one workpiece spindle, no process step is carried out at the other workpiece spindle, whereupon the finished workpiece is traversed into the secondary position by rotating the workpiece spindle holder or traversing the workpiece spindles, in which secondary position said workpiece is removed. Since the workpiece arranged at the other workpiece spindle already is rough-toothed, however, no further main machining can be carried out either during the loading and unloading step. Rather, only after a further change in position of the workpiece spindles, a rough toothing step at the workpiece newly picked up and a deburring step at the rough-toothed workpiece now are effected at the same time. With this process control, only rough toothing (SS) and deburring (WE) hence are carried out at the same time.

The processes can be distributed better in a time-optimised way, when one of the processes is interrupted, when another process is finished. The interrupted process then can be continued again, when the workpiece spindle again arrives at this machining position. This is not very problematic, since at both workpiece spindles the workpiece position is known and due to the rolling coupling also the position of the tool relative to the workpiece. It is easily possible to continue to work at the position at which the process has stopped before. Preferably, the rough toothing step is divided into two partial steps. If due to the load small deviations occur on the tooth flank in this case, said deviations will be eliminated during the fine machining process, i.e., during fine toothing.

Rough toothing, i.e. the roughing step, is composed of an initial cut (AN), in which the milling cutter immerses into the workpiece, and a profiling cut (PS), in which the profile of the toothing is formed. Depending on the slope of the toothing, the ratio of initial cut path and the path for profile formation can vary. In the case of helical toothings with large helix angles, the initial cut path frequently can be distinctly longer than the path for profile formation.

In the exemplary embodiment shown in FIG. 2, the roughing step taking longest therefore is carried out in two partial process steps, an initial cut process (AN) and a profiling cut process (PS). Other than shown in FIG. 1, this allows to work at the main station also during the loading and unloading operation.

In the exemplary embodiment, an initial cut process (AN) each takes place during the deburring step (WE), whereas during the loading and unloading step the profiling cut process (PS) is carried out.

The length of the first and the second partial step of rough toothing can be adapted depending on the time required for deburring and for loading and unloading. It is of course not necessary that during the first partial process only the initial cut is made, and that during the second process only a profiling cut is made. Rather, arbitrary parts of rough toothing can be divided into the first partial step and the second partial step.

The objective of optimization here is that it is possible to work at both machining positions at the same time for as long as possible, while the smoothing cut takes place at the other spindle as the only process without parallel machining

In the exemplary embodiment shown in FIG. 3, on the other hand, the smoothing cut (FF) and a further process take place one after the other, without a change of the machining position taking place in between. At the process times shown in the exemplary embodiment, this leads to the shortest machining times for two workpieces.

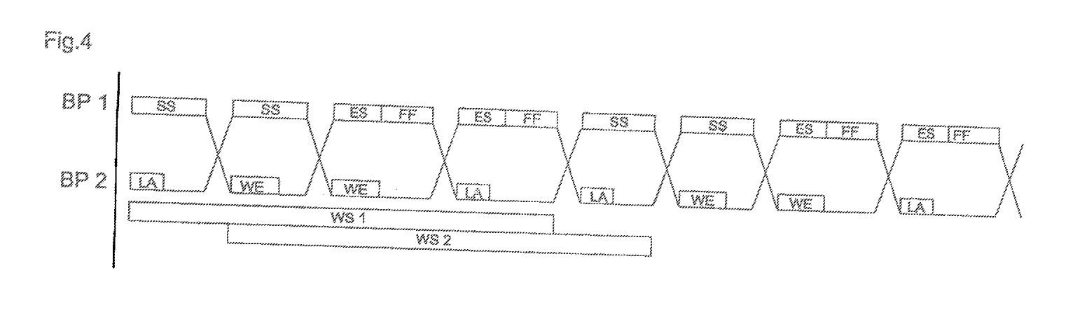

FIG. 4 shows an exemplary embodiment in which in connection with a gear shaping method, in particular a gear planing method, a second rough toothing cut, a so-called leveling cut (ES) is carried out before fine toothing (FF). The two cuts are made one after the other at the main machining station, without pivoting of the workpiece spindle holder or traversing of the workpiece spindles being effected. Care is also taken here that during fine toothing no other process takes place, in order to avoid influencing of the fine toothing. However, this has an only insignificant influence on the entire cycle time, as during the chamfering step (WE) and/or during loading and unloading (LA) the additional leveling cut (ES) is made.

Which process variant achieves optimum results in particular also depends on the length of the individual partial processes as well as on the number of cuts. In gear planing processes in contrast to gear hobbing processes three or more cuts usually take place, until the workpiece is finished. Here as well, many possibilities of process control are available, in order to achieve rather short machining times.

However, it is also decisive here that during the quality-determining smoothing process no influence by a second process occurs at the other machining position.

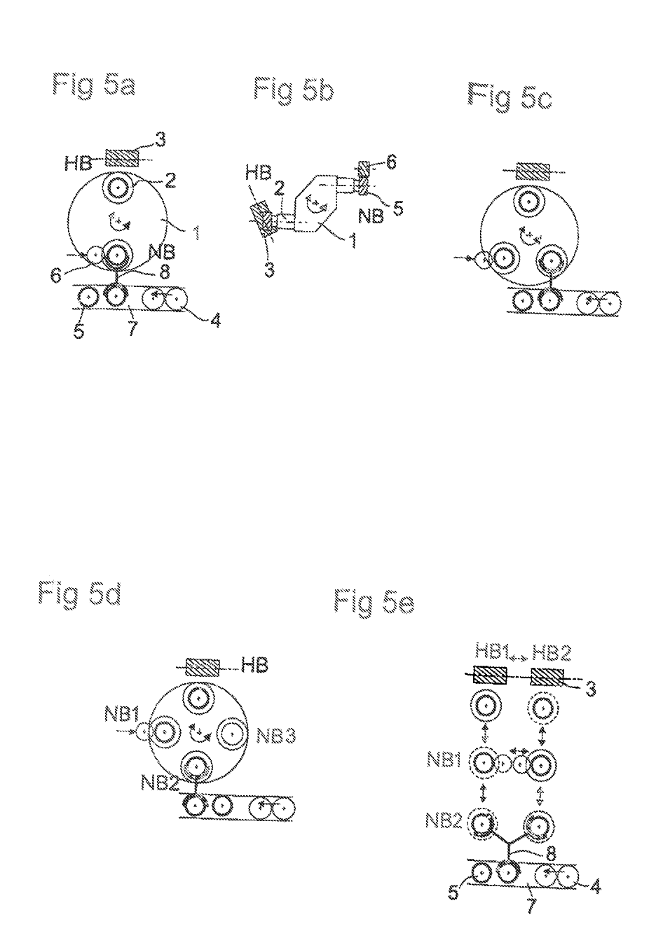

FIGS. 5a-e show various possible concepts with a different number of workpiece spindles. They differ by concepts in which the workpiece spindles are mounted on a common workpiece spindle carrier (FIGS. 5a to 5d) and those in which the workpiece spindles can be traversed independent of each other (FIG. 5e).

By way of example, FIGS. 5a and 5b show variants with two workpiece spindles on a spindle carrier, wherein the main axis of the spindle carrier is arranged parallel or at right angles to the axes of the workpiece spindles.

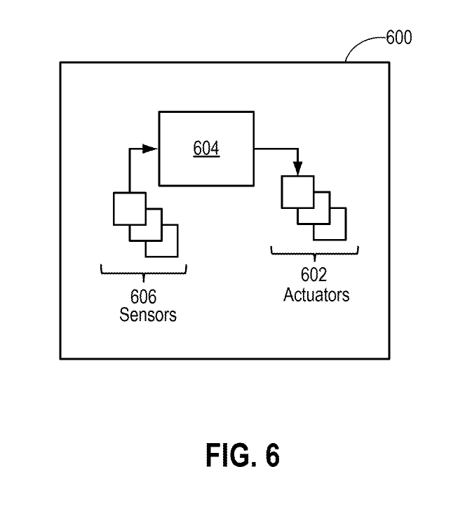

FIG. 6 shows schematically a gear cutting machine 600 having various actuators 602 controlled by a controller 604 responsive to sensors 606. The actuators may be one or more of the various actuators described above, and the controller may include instructions stored in memory for one or more of the methods described above.

### LIST OF ABBREVIATIONS

SS: roughing cut (rough toothing)
FF: smoothing cut (fine toothing)
WE: deburring, in particular roller deburring
LA: loading and unloading
AN: initial cut
PS: profiling cut
WS1: workpiece 1
WS2: workpiece 2
ES: leveling cut (during gear shaping)
HB: main machining position
NB: secondary machining position
1 workpiece spindle holder
2 workpiece spindle
3 tool
4 raw part
5 finished part
6 deburring tool
7 external automation
8 loading system

1. A method for tooth-machining workpieces on a gear cutting machine,
wherein the gear cutting machine includes at least one main machining station and at least one secondary station as well as at least two workpiece spindles,
wherein the two workpiece spindles alternately are traversed into a working region of the main machining station and a working region of the secondary station,
wherein the method for tooth-machining workpieces includes a fine toothing step, in which a workpiece arranged at one of the workpiece spindles is fine-toothed at the main machining station for a duration,
and wherein the method for tooth-machining workpieces includes a secondary machining step, in which a workpiece arranged at one of the workpiece spindles is subjected to secondary machining at the secondary station by material removal and/or material forming, wherein for the duration of the fine toothing carried out at the main machining station no secondary machining each is effected at the secondary station.

2. The method according to claim 1, wherein the method for tooth-machining workpieces furthermore includes a rough toothing step, in which the workpiece arranged at one of the workpiece spindles is subjected to rough toothing at the main machining station, wherein during the rough toothing carried out at the main machining station a secondary machining step and/or a loading and/or unloading step is carried out at the secondary station.

3. The method according to claim 1, wherein the method is a gear milling method with the main machining steps comprising rough milling and fine milling, and the secondary steps comprising loading and unloading of one of the workpiece spindles and deburring.

4. The method according to claim 1, wherein the method is a gear shaping method with main steps comprising rough gear shaping, leveling and fine gear shaping and the secondary machining steps of loading and unloading of one of the workpiece spindle and deburring.

5. The method according to claim 1, with the following steps:
traversing of the workpiece spindles, so that a first workpiece spindle gets into the working region of the main machining station and a second workpiece spindle gets into the working region of the secondary station;
fine toothing of the workpiece picked up at the first workpiece spindle, without a secondary machining being carried out at the secondary station, resulting in a fine-toothed workpiece; and
traversing of the workpiece spindles, so that the first workpiece spindle gets into the working region of the secondary station and the second workpiece spindle gets into the working region of the main machining station.

6. The method according to claim 5, further comprising:
unloading of the fine-toothed workpiece from the first workpiece spindle and loading of one of the workpiece spindles with a new workpiece, without carrying out a main machining step at the main machining station.

7. The method according to claim 5, further comprising:
unloading of the fine-toothed workpiece from the first workpiece spindle and loading of one of the workpiece spindles with a new workpiece, while at least a part of a main machining step is carried out at the main machining station.

8. The method according to claim 1, wherein a main machining step carried out at the main machining station, in particular a rough toothing step, is divided into two partial steps, between which positioning of the workpiece spindles is changed, in particular in order to fine-tooth the workpiece arranged on the other workpiece spindle, wherein the main machining step preferably is divided into a first partial step, in which an initial cut is carried out, and a second partial step, in which a profiling cut is carried out.

9. The method according to claim 1, with the following steps:
traversing of the at least two workpiece spindles, so that a first workpiece spindle gets into the working region of the main machining station and a second workpiece spindle gets into the working region of the secondary station;
fine-toothing of the workpiece picked up at the first workpiece spindle and carrying out the secondary machining and/or an unloading and loading step at the secondary station in at least two non-overlapping time intervals, in particular one after the other; and
traversing of the workpiece spindles, so that the first workpiece spindle gets into the working region of the secondary station and the second workpiece spindle gets into the working region of the main machining station.

10. A gear cutting machine with at least one main machining station, at least one secondary station and at least two workpiece spindles, wherein the two workpiece spindles are alternately traversable into a working region of one of the main machining stations and a working region of one of the secondary stations; and
a controller for automatically carrying out a fine toothing step, in which a workpiece arranged at one of the workpiece spindles is fine-toothed at the main machining station for a duration, and a secondary machining step after the fine toothing step, in which a workpiece arranged at one of the workpiece spindles is subjected to secondary machining at the secondary station by material removal and/or material forming, wherein for the duration of the fine toothing carried out at the main machining station no secondary machining is effected at the secondary station.

11. A system comprising:
a controller including instructions stored in memory for:
automatically carrying out, in cooperation with a gear cutting machine with at least one main machining station, at least one secondary station and at least two workpiece spindles, wherein the two workpiece spindles are alternately traversable into a working region of one of the main machining stations and a working region one of the secondary stations:
a fine toothing step, in which a workpiece arranged at one of the workpiece spindles is fine-toothed at the main machining station for a duration; and
a secondary machining step after the fine toothing step, in which a workpiece arranged at one of the workpiece spindles is subjected to secondary machining at the secondary station by material removal and/or material forming, wherein for the duration of the fine toothing carried out at the main machining station no secondary machining each is effected at the secondary station.
